(19) United States
(12) Patent Application Publication
(10) Pub. No.: US 2016/0247226 A1
(43) Pub. Date: Aug. 25, 2016

(54) Software, Systems, Apparatus, Methods, Media, and Distribution for Creating Standardized Indices to Measure Actual Price Risk

(71) Applicant: Krause Robert, Gillette, NJ (US)

(72) Inventor: Krause Robert, Gillette, NJ (US)

(21) Appl. No.: 14/851,007

(22) Filed: Sep. 11, 2015

Related U.S. Application Data
(63) Continuation of application No. PCT/US15/16524, filed on Feb. 19, 2015.

(51) Int. Cl. G06Q 40/04

(52) U.S. Cl. CPC G06Q 40/04

(57) ABSTRACT

Computer systems, software, systems, apparatus, methods, media, and distribution for creating indices to measure the actual price risk of an underlying. In one aspect, an electronic, computer-controlled system for electronically creating, recording, and disseminating the indices based on realized volatility. In a first embodiment, the system comprises: computer-compatible electronic memory including an electronically encoded representation of the indices based on the realized volatility of an underlying. The electronically encoded representation includes an electronically encoded representation of underlying reference price data, a realized volatility or variance formula (or statistical derivation of a formula based on realized volatility or realized variance), a time period. Further, the electronically encoded representation includes an electronically encoded representation of the adjustments to the data or the formulas. Yet further, the electronically encoded representation includes an electronically encoded representation of the result of the calculation of the formulas including all adjustments.

### 1 CROSS-REFERENCE TO RELATED APPLICATIONS

This application claims priority to PCT Application Serial No. PCT/US15/16524, filed 19 Feb. 2015, the entire disclosure of which is incorporated herein by reference in its entirety and for all purposes.

### 2 NOTICE OF COPYRIGHT

Portions of this patent application include materials that are subject to copyright protection. The copyright owner has no objection to the facsimile reproduction by anyone of the patent document itself, or of the patent application, as it appears in the files of the United States Patent and Trademark Office, but otherwise reserves all copyright rights whatsoever in such included copyrighted materials.

### 3 BACKGROUND OF THE INVENTION

3.1 Field of the Invention

The present invention provides software, systems, apparatus, methods, media, and distribution for creating indices to measure the actual price risk exhibited in the marketplace of some underlying. The present invention thus has applications in the fields of computer science, and computerized finance, derivatives, trading, risk management, insurance, securities, investments, and banking.

3.2 The Related Art

An index is a perpetual calculation created from an underlying (or a group of underlyings). An index must be based on a calculation of some kind. It could be something as simple as an averaging process, or more complex, such as the calculation of realized volatility. The calculation must be performed on “something.” In the financial markets, the “thing” is the price of an underlying (or a group of underlyings). As described earlier, a typical equity index may be composed of a group of like-kind equities, such as a country index or a sector index. The novel invention described herein is based on a realized volatility calculation and/or other related statistical calculations on one underlying. Finally, the calculation must be continuous or perpetual such that new index values are created each day.

Given a formula and some data, one of ordinary skill can calculate a result. However, just calculating a result one time, or calculating the result over time, does not make an index. There must be a predefined process that leads to an “institutional quality” result. For example, what happens to the index when a market disruption event occurs to the normal functioning of the underlying's market price? What happens if the market disruption occurs only for a short time—such as a power outage? What happens when the event lasts for days or weeks? What happens when the underlying goes through a contrived event that affects the price (but not the value) and hence the calculation of realized volatility in an adverse way? What happens if the underlying is not continuous, but expires, such as a futures contract? Which underlying assets are or are not viable (private equity is an asset that is not compatible with a realized volatility calculation because a daily price is not available)? Should the index use the most recent traded price or some combination of the current bid and offer? Which formula is the best or most useful to market participants? Even if the best methodology is possible, creating an index that cannot be verified is not as useful.

In other words, it may be easy to calculate the result of a formula. However, producing a widely disseminated index to the public that is robust, accurate, free from contrived effects, handles all type of market disruption events, and uses a broad array of underlyings is what makes a simple formula and associated market data into an institutional quality index.

The primary reason to create an index is to standardize a measurement for easy comparison between or among similar indices. Standardization allows for comparison between and among different underlying assets. Comparison is key to understanding relationships. In the case of risk indices, because of standardization, one can compare, for example, the risk of stocks to gold, the risk of interest rates to corn, and risk of the U.S. dollar to the temperature variability in Paris. In short, it does not matter what underlying is used; comparing the risk based on standardized indices is key to understanding how risk is interconnected among underlyings. Standardized indices also can be used to settle a financial instrument, such as, but not limited to, a futures contract, options contract, or swap contract. Doing so would allow the market participant to speculate upon or hedge against the movement in the index. Regardless of whether a tradable instrument is offered, or used, an index can guide investors' decisions in other financial matters. Therefore, whether one profits from the index directly (through tradable instruments on the index), or indirectly (through other financial vehicles), a standardized index can be quite useful to a market participant.

The drawback of standardization is that nuances of a particular asset may be lost. For example, a stock price cannot go below zero. The foreign currency market has no “zero,” as the exchange rate between two currencies is infinite in both directions (e.g., one million dollars for each euro, or one million euros for each dollar). Interest rates were thought to have a zero interest-rate floor, but in the past few years, rates actually fell into negative territory. However, because rates are reported as a percent from 100%, it is nearly impossible for the reported price to rise much above 100%. Yet, the value can move below zero into negative prices implying a rate above 100% (i.e., a 200% interest rate becomes a −100% price, or 100%−200%).

The point is that each market may exhibit a unique attribute that does not lend itself to a standard method of measurement. However, even so, the standard measure, while not encompassing of all attributes of a particular asset, still shows relative performance or risk of each. In this way, market participants would need to adjust the index value for the asset's particular nuances only and not do a “double adjustment” for an asset's particular nuances and for a varying risk methodology. Therefore, while not a perfect solution, standardized indices allow for the comparison between or among underlying assets leaving just the asset-particular nuances to the index receiver.

One measure of risk is “implied volatility”, which is a measure of the cost to insure a perceived risk. Implied volatility uses options premiums traded in the marketplace to impute or imply a volatility value. Another form of volatility measurement, called “realized volatility”, is a measure based on actual risk. Realized volatility is the “actual volatility,” “statistical volatility,” or “asset volatility” that the underlying asset has displayed over a specific period. The term “realized volatility” is very closely related to “standard deviation.” Realized volatility is a specific form of standard deviation based on the daily returns of an underlying (instead of actual prices) and annualize the results, standard deviation becomes realized volatility. In other words, realized volatility is reality-based; implied volatility is opinion-based.

Related to volatility (realized or implied) is “realized- (or implied) variance”. The difference between realized variance and realized volatility is in the scale of measurement: variance is the square of volatility. In other words, if volatility goes up by 5 times, variance goes up by 25 times (5²). Variances are linear and additive, volatilities are not; so, variance is much easier to work with than is volatility in certain respects. For example, if we wanted to calculate the volatility of two months including July and August, one cannot just average the volatilities of July and August. In other words, the two-month volatility is not the same as the weighted average of two one-month volatilities. However, if one were using variance, such a linear, weighted average is the correct calculation. Variance is easier to hedge in the marketplace using standard options.

However, there are considerable drawbacks to variance as a trading vehicle beyond these two benefits. The variance values can be immense. Since every volatility value gets squared, even small moves can lead to huge gains or losses from a tradable variance instrument. In addition, because of the wide variability, margin amounts (the amount of cash needed to post in order to hold a position) can be daunting. Finally, while variance is useful in mathematics, variance values do not make intuitive sense to people. In other words, it is hard to relate a variance value to the variability of the underlying.

From the foregoing, it's clear that markets need a standard methodology to measure the actual risk of the underlying. The present invention meets these and other needs.

### 4 SUMMARY OF EMBODIMENTS OF THE INVENTION

The present invention provides software, systems, apparatus, methods, media, and distribution for creating indices to measure the actual price risk of an underlying. Further, such indices could be used in the trading, pricing, and bidding of securities, futures contracts, swap contracts, securities options, index options, futures options, swap options, and other derivative instruments; and systems relating thereto. As noted above, such indices are new and address important limitations in current markets and financial operations. Because modern markets and financial operations no longer use pencil-and-paper type operations, but rather depend on the speeds and data volumes that can only be managed using high speed electronic digital computers, electronic computer memory, and fast high-security electronic communications networks, the embodiments of the systems, methods, software, and apparatus of the invention described herein are necessarily electronic in nature.

In one embodiment, the present invention provides an electronic, computer-controlled system for electronically creating, calculating, recording, and disseminating standardized indices based on the actual price risk of an underlying. In a first embodiments, the system comprises a computer-accessible, computer-controlled electronic memory holding electronically encoded representations of indicies, said representations of said indicies being determined at least in part by electronic computer-controlled calculations of the actual price movements of said underlying. The representations are further determined by electronic computer-controlled calculations based on electronically encoded representations of non-trading days, rolling between expiring underlyings, market disruption events, and phantom volatility of said underlying.

In other embodiments, the electronically encoded representations of the indices are further determined by electronic computer-controlled calculations based on electronically encoded representations of predetermined time periods of the underlying; in more specific embodiments, the time periods are one-day, approximately one-week, approximately one-month, approximately three-month, or approximately twelve-month time periods of the underlying.

In more specific embodiments of the first embodiment, the electronically encoded representation is further determined by electronic computer-controlled calculations based on electronically encoded representations of inter-day realized volatility of the underlying, the intra-day realized volatility of the underlying, the electronically encoded GARCH-based models, RFSV (Rough Fractional Stochastic Volatility) models, and HARK (Heterogeneous Autoregressive with Kalman filter) models, of forecast realized volatility and realized volatility of volatility of the underlying, electronically encoded representations of the realized volatility of realized volatility of the underlying, electronically encoded representations of the realized correlation between the underlying and the realized volatility of the underlying, electronically encoded representations of the realized correlation of a plurality of underlyings, electronically encoded representations of real-time realized volatility of the underlying, and electronically encoded representations of inter-day, intra-day, daily, or real-time realized variance of the underlying.

In another more specific embodiment of the first embodiment, the underlying is an index, and the electronically encoded representation is further determined by electronic computer-controlled calculations based on electronically encoded representations of the realized volatility of the underlying and the realized volatility of the components of the underlying.

In another aspect, the present invention provides a method for electronically creating, calculating, recording, and disseminating standardized indices based on the actual price risk of an underlying. In a first embodiment, the method comprises calculating under computer control electronically encoded representations of actual price movements for the underlying using electronic, computer-controlled calculations of electronically encoded representations of non-trading days, rolling between expiring underlyings, market disruption events, and phantom volatility of the underlying; and electronically calculating under computer control electronic representations of the indices using electronic, computer-controlled calculations of the electronically encoded representations of the actual price movements.

In other embodiments, the electronically encoded representations of the indices are further determined by electronic computer-controlled calculations based on electronically encoded representations of predetermined time periods of the underlying; in more specific embodiments, the time periods are one day, approximately one week, approximately one month, approximately three month, or approximately twelve-month time periods of the underlying.

In more specific embodiments of the first embodiment, the electronically encoded representation is further determined by electronic computer-controlled calculations based on electronically encoded representations of inter-day realized volatility of the underlying, the intra-day realized volatility of the underlying, the electronically encoded GARCH-based models, RFSV (Rough Fractional Stochastic Volatility) models, and HARK (Heterogeneous Autoregressive with Kalmamn filter) models, of forecast realized volatility and realized volatility of volatility of the underlying, electronically encoded representations of the realized volatility of realized volatility of the underlying, electronically encoded representations of the realized correlation between the underlying and the realized volatility of the underlying, electronically encoded representations of the realized correlation of a plurality of underlyings, electronically encoded representations of real-time realized volatility of the underlying, and electronically encoded representations of inter-day, intra-day, daily, or real-time realized variance of the underlying.

In another more specific embodiment of the first embodiment, the underlying is an index, and the electronically encoded representation is further determined by electronic computer-controlled calculations based on electronically encoded representations of the realized volatility of the underlying and the realized volatility of the components of the underlying.

In a third aspect, the present invention provides a non-transitory computer-readable medium containing a computer program product for operating a computer data processing device having an operating system, the computer program product being configured to enable the computer data processing device to electronically create, record, trade, and settle standardized indices based on the actual price risk of an underlying. In first embodiment, the computer program product is configured to enable the computer data processing device to perform actions comprising: calculating under computer control electronically encoded representations of actual price movements for the underlying using electronic, computer-controlled calculations of electronically encoded representations of non-trading days, rolling between expiring underlyings, market disruption events, and phantom volatility of the underlying; and electronically calculating under computer control electronic representations of the indices using electronic, computer-controlled calculations of the electronically encoded representations of the actual price movements.

In other embodiments, the electronically encoded representations of the indices are further determined by electronic computer-controlled calculations based on electronically encoded representations of predetermined time periods of the underlying; in more specific embodiments, the time periods are one-day, approximately one-week, approximately one-month, approximately three-month, or approximately twelve-month time periods of the underlying.

In more specific embodiments of the first embodiment, the electronically encoded representation is further determined by electronic computer-controlled calculations based on electronically encoded representations of inter-day realized volatility of the underlying, the intra-day realized volatility of the underlying, the electronically encoded GARCH-based models, RFSV (Rough Fractional Stochastic Volatility) models, and HARK (Heterogeneous Autoregressive with Kalmamn filter) models, of forecast realized volatility and realized volatility of volatility of the underlying, electronically encoded representations of the realized volatility of realized volatility of the underlying, electronically encoded representations of the realized correlation between the underlying and the realized volatility of the underlying, electronically encoded representations of the realized correlation of a plurality of underlyings, electronically encoded representations of real-time realized volatility of the underlying, and electronically encoded representations of inter-day, intra-day, daily, or real-time realized variance of the underlying.

In another more specific embodiment of the first embodiment, the underlying is an index, and the electronically encoded representation is further determined by electronic computer-controlled calculations based on electronically encoded representations of the realized volatility of the underlying and the realized volatility of the components of the underlying.

### 5 DETAILED DESCRIPTION OF SOME EMBODIMENTS OF THE INVENTION

### 5.1 Definitions

Unless indicated otherwise, the following terms and definitions will apply herein.
Underlying As used herein an “underlying” is defined as something from which the index derives its value. A suitable underlying can be any subject matter having a daily or intra-day price, including, but not limited to: a tangible or intangible asset, instrument, basket, index, security, derivative, bond, debt, foreign currency, commodity, option, any measurement (such as snowfall, rainfall, temperature, carbon release or capture, emissions, heat, light, electricity, gas, liquid, solid, energy, air, water, etc.); any calculation of such subject matter (such as standard deviation, implied volatility, realized volatility, realized variance, correlation, dispersion, difference, ratio, regression, autocorrelation, etc.); and any other quantity that can be determined with sufficient robustness in order to have a daily value and/or real-time value. Such quantities and their determination will be understood by those having ordinary skill in the art.
Realized Volatility As used herein, “realized volatility” includes inter-day realized volatility, intra-day realized volatility, real-time realized volatility, inter-day realized variance, intra-day realized variance, and real-time realized variance, unless specifically mentioned.
Underlying Reference Price As used herein, “Underlying Reference Price” (“URP”) refers to the actual daily ending price that the underlying has displayed, or will go on to display. The URP is the “closing,” “last,” “final,” or “settlement” price for the day. The URP is an especially attractive value for calculating Realized Volatility because of its ease of use, transparency, and wide dissemination to market participants. However, there are two exceptions: The first is during a market disruption event when the day's URP is not available. In such a case, one needs to follow the rules on Market Disruption Events detailed later in this document. The second is when calculating the real-time version of an index. The real-time version uses the real-time or the most up-to-the-second underlying price for the current day only. In other words, throughout the trading day (“today”) as the underlying price gets updated, this most recent value is the URP even though the market has yet to close. Such an exception occurs on today's value only and not for any other day in the past.
Underlying High Price As used herein, “Underlying High Price” (“UHP”) is defined as the highest attained price for the day, whenever that occurred. Note: While the high price most days occurs prior to the closing price for the day, one has to wait until the end of the day in order to identify which price was the highest throughout the day.
Underlying Low Price As used herein, “Underlying Low Price” (“ULP”) is the lowest price for the day.
Underlying Open Price As used herein, “Underlying Open Price” (“UOP”) is the first trade or opening price for the day.

### 5.2 Introduction

The present invention provides software, systems, apparatus, methods, media, and distribution for creating indices to measure the actual price risk of an underlying. Such indices are based on realized volatility or its closely related “cousin” realized variance. As noted above, such electronic representations, manipulations, and communication are necessary to enable the use of indices given the data volumes and trading speeds of modern markets and finance operations.

The invention described herein is implemented in digital electronic circuitry, or in computer hardware, firmware, software, or in combinations thereof. As will be apparent to those having ordinary skill in the art, only computer implementation of the invention can enable the transaction volumes and frequencies necessary for modern investment operations involving the novel financial indices described herein. Data on the investment instruments described herein, generation, trading, and settling of such indices and their trades, the creation and maintenance of indices, and other relevant information are stored, manipulated, and transmitted using such digital electronic circuitry, or in computer hardware, firmware, software, or in combinations thereof. Apparatus of the invention can be implemented in a computer program product tangibly embodied in a non-transitory, machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on programmable systems including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a computer memory device, such as, but not limited to, read-only memory and random access memory. Generally, a computer will include one or more mass storage devices for storing data files; such devices include magnetic disks, such as internal hard disks and removable disks; magneto-optical disks; and optical disks.

Storage devices suitable for tangible (i.e., non-transient) provision of computer program instructions and data described herein include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). All of these are referred to herein generally as “computer-readable media containing computer-readable program control devices.” To provide for interaction with a user, the invention can be implemented on a computer system having a display device such as a monitor or LCD screen for displaying information in conjunction with the inversion to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, can be received from and output to the network, for example, in the form of a computer data signal embodied in a carrier wave. The above-described devices and materials will be familiar to those of skill in the computer hardware and software arts.

It should be noted that the present invention employs various computer-implemented operations involving data, in particular data described above in conjunction with the invention, stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered, however, that all of these and similar terms are to be associated with the appropriate physical quantities and are merely convenient labels applied to these quantities.

The present invention also relates to devices, systems or apparatus for performing the aforementioned operations. The system can be specially constructed for the required purposes, or it can be a general-purpose computer selectively activated or configured by a computer program stored in the computer. The processes presented above are not inherently related to any particular computer or other computing apparatus. In particular, various general-purpose computers can be used with programs written in accordance with the teachings herein, or, alternatively, it can be more convenient to construct a more specialized computer system to perform the required operations.

### 5.3 Implementation of the Invention

Using the description of hereinbelow, one having ordinary skill in the art can provide the software, systems, apparatus, methods and media of the invention by implementing the indices as described below in the various electronic formats, encodings, and representations compatible with the electronic, computer-controlled systems, hardware, and media described above.

### 5.3.1 Indices

This document describes the process of creating indices to measure realized volatility in a standardized manner on a daily and real-time basis. All real-time and daily indices base their measurement on the movement, regardless of direction, of some underlying, over a predefined time frame, and are expected to be published on a multitude of underlyings. As those with ordinary skill in the art will understand, realized volatility can be used as the basis for other statistical measures to create yet other indices such as, but not limited to, realized variance, realized correlation, intra-day realized volatility, inter-day realized volatility, realized dispersion, and realized volatility of realized volatility.

### 5.3.2 Daily Versus Real-Time

No index currently has both daily and real-time versions simultaneously. This is a novel invention itself. Most indices are updated on a real-time, or nearly real-time, basis. Some are calculated daily. But, none have both. Why the distinction in this case? Typically, volatility is measured on a daily basis only. Therefore, the daily indices correspond to the standard of using only daily (i.e., closing) URPs. On the expiration day of the corresponding tradable instrument, the closing index value will be used for contract settlement.

### 5.3.3 Real-Time Indices

Traders often demand indices that are updated more frequently. The problem is how to furnish a real-time version for a daily volatility index. The invention described herein solves this conundrum by time weighting the most current day's return and time weighting the longest-dated return by the remaining weight so that both partial weights total 100%.

For example, collect the most up-to-the-second price of the underlying (today's URP) and weight it by the time through a 24-hour day. This means if we are three-quarters of the way through the current day, then the weight of the most recent price is 75% (in the formula, this term is self-weighting, so no specific weight is needed). The remaining 25% weight (100%−75%, in the formula, this term needs to be specifically weighted) is used for the farthest date in the calculation period such that the first day at 25% weight and today's weight of 75% total 100%. Note: the real-time formula results in exactly the same value as the daily formula at the instant when the market closes.

### 5.3.4 Daily Indices

Exemplary embodiments of the invention include one or more of the following nine daily indices.
Realized volatility (“RVOL”)
Realized variance (“RVAR”)
Realized volatility of volatility (“RVOV”)
Modified GARCH forecasts of realized volatility (“FVOL”)
Modified GARCH forecasts of realized volatility of volatility (“FVOV”)
Intra-day realized volatility (“DVOL”)
Realized correlation between the underlying and its volatility (“VCOR”)
Realized correlation between two underlyings (“XCOR”)
Realized dispersion between the RVOL of the index and the RVOLs of the individual components that make up the index (“DISP”). (This is applicable only when the underlying is an index itself.)
Rough Fractional Stochastic Volatility (“RFSV”) forecasts of realized volatility.
Heterogeneous Autoregressive with Kalman filter (“HARK”) forecasts of realized volatility.

### 5.3.5 Constraints

As those with ordinary skill in the art would understand, any time frame can be used with one “loose” constraint. The constraint is that statisticians have defined a minimum number of 20 data points for a standard deviation calculation to be valid statistically. Because volatility is based on principles of standard deviation, that constraint carries through such that there normally need to be 20 or more returns. The exception to the rule is during a market disruption event. In such a case, it is possible for the count of URPs, and hence returns, to drop below this number. However, such an event is rare and would not be sufficient cause to invalidate the entire approach. This is why the constraint is labeled a “loose” constraint. In addition, while not statistically meaningful, market participants often would like to see a shorter time frame view of volatility. For this reason, the constraint is removed and the index may be disseminated over a time frame as short as one day.

### 5.3.6 Commercially Viable Time Frames

Again, while any time frame can be used, the inventor believes that only certain time frames will be commercially viable. The time frames correspond to the four horizons of traders' typical trading styles. The six horizons are: ultra-short-term trading (intra-day trading), inter-day trading (one day), weekly trading (one week), short-term trading (one month), medium-term trading (three months), and long-term trading (one year). Beyond one year, generally, a “trader” is considered an “investor”; and, while volatility is important to an investor, the volatilities beyond one year change so little that they are generally ignored or treated as a constant.

For ease of reading beyond this point, the one-day and one-week indices will be ignored. All principles discussed apply to daily and weekly indices as well. Any time frame may be used in the calculation of realized volatility and its related statistics. It should be noted that the longer term realized volatility indices are expected to be most useful, with the one-month index to be the most useful of all. However, any variation to the time frame is within the scope of the invention described herein. The longer term indices will have a 1, 3, or 12 prefix as a more precise label. For example, the 1-month RVOL index will have the label 1RVOL; the 3-month RVOL index will have the label 3RVOL; similarly, the 12-month RVOL index will have the label 12RVOL. Note: The 1RVOL index actually encompasses 21 returns from 21 trading days (approximately 1 month of trading). The 3RVOL index includes 63 trading days (3 months of trading); and, the 12RVOL index uses 252 trading days (12 months). Similarly, this labeling approach applies to any of the other daily indices. For example: 1RVOV (the 1-month volatility of volatility index), 12DVOL (the 12-month intra-day volatility index), and 3DISP (the 3-month dispersion index).

An exception occurs for the real-time index. Because the real-time index is a special case, it will be referred to separately as VOL.

RVOL indices use the daily formula to provide a historical perspective of realized volatility. In addition, while any index described herein could be used to settle a tradable instrument at expiration of the instrument, RVOL is expected to be the primary index used for such purposes.

RVOV indices use the daily formula a second time to provide a historical perspective of “vol of vol” (realized volatility of realized volatility, or realized volatility of RVOL). This is important because when trading instruments on volatility itself, we need to know how volatile they are. Additionally, we need this value for margin purposes and for risk-control purposes. Specifically, it is expected that the following combinations would be the most useful: the 21-trading-day vol of 21-trading-day vol (1RVOV), 21-trading-day vol of 63-trading-day vol (3RVOV), and 21-trading-day vol of 252-trading-day vol (12RVOV).

FVOL indices use a modified GARCH model (Generalized Autoregressive Conditional Heteroskedasticity) to forecast future realized volatility based on historical volatility. They were developed by Nobel laureate professor Robert Engle of New York University Stern School of Business in New York City. FVOV indices will similarly be based on GARCH models. GARCH models have been in the public domain for years and can be found in several publications, papers, and on the Internet.

### 5.3.7 Defined Days

As noted, there are three time frames for indices to be most useful: 21 trading days, 63 trading days, and 252 trading days. However, because of the potential for a market disruption event (MDE) where the market never opens and hence never closes, the actual number of trading days may be less than expected. When this occurs, the number of actual trading days (“trading days”) will be less than the expected days (“Defined Days”). Note: We cannot count a non-trading day's volatility as zero just because a market disruption event eliminates an entire day of trading. The proper way to handle an MDE is to calculate the realized volatility over the remaining days. Details will be furnished below.

For further clarification: weekends are not trading days; holidays are not trading days; a regularly scheduled trading day is a “trading day.” However, a trading day where the market and all of its surrogate markets do not open, and hence cannot close, causes the number of trading days to be less than the number of Defined Days for purposes of the index calculation.

### 5.3.7.1 Formulas

The formulas outlined in this section are only for the “normal” case. As was mentioned earlier, in order to create an institutional quality index, a number of unique factors may have to be considered, including, but not limited to, MDEs, dividends, stock splits, futures expirations, etc. These special situations are explained in the following section. Again, the formulas outlined are for the standard case without these adjustments. Any adjustments will need to be handled separately.

### 5.3.7.2 Standard Deviation Formula

An index could be created from standard deviation. However, it would not conform to the way most traders think of price variability in the marketplace. For one, standard deviation uses actual URPs, not returns. In addition, the result is not annualized. Market participants have come to expect market variability to be in volatility terms, not standard deviation terms. However, since volatility is just a specific form of standard deviation, it is instructive to see the formula for the latter.

$$s . d . = \sqrt{\frac{1}{n - 1} {\sum }_{t = 1}^{n} {( {URP}_{t} - \overline{URP} )}^{2}}$$

Where: s.d. is the standard deviation, n is the number of days in the observation period, t is a counter representing each trading day, URPₜ is the specific day's underlying reference price, and U̅R̅P̅ is the mean of all URPs in the observation period

### 5.3.7.3 Standard Variance Formula

$$variance = \frac{1}{n - 1} {\sum }_{t = 1}^{n} {( {URP}_{t} - \overline{URP} )}^{2}$$

### 5.3.7.4 Realized Volatility: Inter-Day Formula (Daily Close-to-Close)

While any index described herein could be used as the basis for a tradable instrument, it is expected that the daily close-to-close formula will be the flagship index used for such tradable instruments. It converts URPs to returns, annualizes the result, sets the annualization factor to a constant 252 trading days, sets the mean to zero, and sets the degrees of freedom to zero.

$$RVOL = \sqrt{\frac{252}{n} {\sum }_{t = 1}^{n} {R}_{t}^{2}}$$

Where: RVOL is realized volatility, 252 is a constant representing the approximate number of trading days in a year, Rₜ is continuously compounded daily returns, defined by the following formula:

$${R}_{t} = ln ( \frac{{URP}_{t}}{{URP}_{t - 1}} )$$

URPₜ₋₁ is the specific day's underlying reference price for the trading day immediately prior to t

### 5.3.7.5 Realized Variance: Inter-Day Formula (Daily Close-to-Close)

$$RVAR = \frac{252}{n} {\sum }_{t = 1}^{n} {R}_{t}^{2}$$

### 5.3.7.6 Realized Volatility: Intra-Day Formula (Daily Open, High, Low, and Close)

The intra-day formula is useful because intra-day volatility (i.e., the intra-day range) is not always the same as inter-day (i.e., close-to-close) volatility. With such an index, one can discern the risk and reward of executing any particular trading strategy within the day versus waiting until the close.

$$DVOL = \sqrt{\frac{252}{n} {\sum }_{i = 1}^{n} {( ln ( \frac{{UOP}_{i}}{{URP}_{i - 1}} ) )}^{2} + \frac{252 π}{8} {\sum }_{i = 1}^{n} {( \frac{ln ( \frac{{UHP}_{i}}{{ULP}_{i}} )}{n} )}^{2}}$$

Where: DVOL is intra-day realized volatility, URPᵢ is underlying reference price, UOPᵢ is the underlying opening price, UHPᵢ is the underlying high price, and ULPᵢ is underlying low price.

### 5.3.7.7 Realized Volatility: Dispersion

The realized dispersion formula can only be used if the underlying is an index itself (and the underlying index must have at least two components). If one calculates the realized volatilities of each index component and the volatility of the index itself, one will find a relationship between or among the risk of the individual securities and the index.

In other words, a dispersion index allows one to ascertain the amount of “internal” volatility of an index.

$$DISP = \sqrt{( {\sum }_{i = 1}^{c} {w}_{i} {RVOL}_{i}^{2} ) - {RVOL}_{index}^{2}}$$

Where: DISP is realized dispersion, c is the number of components in the underlying index, wi is weight of each component in the index, RVOLᵢ is the RVOL index of the individual component, and RVOL_{index} is the RVOL index of the underlying index.

### 5.3.7.8 Realized Correlation: Underlying Versus its Volatility

There are two types of realized correlation indices. The one described next is the correlation between the underlying and its own volatility.

$$VCOR = \frac{252}{n} \frac{{\sum }_{i = 1}^{n} {R}_{i} {R}_{{RVOL}_{i}}}{RVOL RVOV}$$

Where: VCOR is realized correlation index between an underlying and its volatility R_{RVOL}_{ᵢ} is the return of the RVOL index each day.

### 5.3.7.9 Realized Correlation: Underlying Versus Underlying

Realized correlation uses the RVOL Indices in the denominator for the calculation of correlation. Because the RVOL indices are created according to the novel process outlined herein, the XCOR index series, outlined immediately below, will be unique as well.

$$XCOR = \frac{252}{n} \frac{{\sum }_{i = 1}^{n} {R}_{{x}_{i}} {R}_{{y}_{i}}}{{RVOL}_{x} {RVOL}_{y}}$$

Where: XCOR is realized correlation index between two underlyings, Rₓ_{ᵢ} is the daily return of underlying x, R_{y}_{ᵢ} is the daily return of underlying y, RVOLₓ is the realized volatility of underlying x, and RVOL_{y} the realized volatility of underlying y.

### 5.3.7.10 Realized Volatility: Real-Time Formula

The real-time realized volatility formula uses the number of seconds in a day to weight the first day and last day's returns as if those two days made up only one day. The rest of the days are processed normally as in the close-to-close formula.

$$VOL = \sqrt{\frac{252}{n} [ \frac{86 , 400 - s}{86 , 400} {R}_{1}^{2} + {\sum }_{t = 2}^{n} {R}_{t}^{2} + {R}_{n + 1}^{2} ]}$$

Where: 86,400 is the number of seconds in a day, n+1 is today, s is number of seconds up to the current moment in time of the current day (n+1) beginning from the time of the most recent market close (day n), excluding intervening weekend days and holidays, R₁ is return for first day (day 1) of the period (from URP day zero to URP day 1). And Rₙ₊₁ is partial return (using the URP of the most up-to-the-second underlying price and the URP of the prior day). (Note: For clarification, the non-italic “R” denotes partial return; all other returns are full-day returns.)

### 5.3.7.11 Realized Variance: Real-Time Formula

$$VAR = \frac{252}{2} [ \frac{86 , 400 - s}{86 , 400} {R}_{1}^{2} + {\sum }_{t = 2}^{n} {R}_{t}^{2} + \frac{s}{86 , 400} {R}_{n + 1}^{2} ]$$

### 5.3.8 Time of Day

For the purposes of the above calculation of the number of seconds, s, within the current trading day, the reckoning does not necessarily start at the beginning of the day (midnight), but rather at the closing time of the market on the previous trading day. For example, the U.S. stock market closes at 4:00 PM Eastern Time (16:00 on a 24-hour clock).

Therefore, the end of the trading day is 4:00 PM and “tomorrow's” trading day begins immediately afterwards. If the current time is 7:00 PM (19:00), the current day's second count is 10,800 (60 seconds per minute×60 minutes per hour×3 hours after the market's close). To continue with this example, three hours is 3/24 (or 0.125 expressed as a decimal) of a whole day. Similarly, 10,800 seconds is 10,800/86,400 (or the same 0.125 expressed as a decimal) of a whole day. Note: It makes no difference if the market is indeed open 24 hours. If the market opens at, say, 9:30 AM the following morning, this is 17.5 hours after the market closed on the previous day; thus, 17.5/24 hours, or 63,000/86,400 seconds, or 0.7292 weight for the current day's (n+1) most recent return would be used in the real-time calculation.

### 5.3.9 Trading Periods in a Year

To determine the number of trading periods in a year, one is supposed to use the actual number of trading days in a year. This is, normally, 252 in the U.S. Other countries have different holiday schedules, hence a different number of trading days. In addition, leap year could change the number of days. Most traders believe that adjusting for the vagaries of the calendar, to get an exact number, is not worth the effort. And, there could be insurmountable problems as well. What happens if one is trading the currency: U.S. dollar (USD)/Japanese yen (JPY)? The two countries have different holiday schedules and hence each would have a different annualization factor. This means that the calculation of the volatility of the exact same USD/JPY foreign exchange rate would yield two different results depending on the country of choice! Obviously, this is not acceptable. Therefore, a reasonably close constant would be better than a varying exact value. For this reason, we use 252 as the annualization factor. But, as those skilled in the art would understand, other similar numbers ranging from approximately 240 (corresponding to a country with a large number of holidays, say, 20 in a year) to 260 (corresponding to a country with no holidays in a year) could be envisioned. This annualization factor could be adjusted in the future depending on market forces. For example, if trading changed from a 5-day-a-week schedule to a 6-day-a-week schedule, we would need to adjust the annualization factor by adding 52 to the above values.

5.3.10 Formula Transition from Daily to Real-Time

The essence of how to convert from a daily index to the real-time index is to continue to calculate precisely 21-day realized volatility even while we are within the new, most recent, day (“Today”).

For instance, if we are halfway through the current day (n+1), we will use the most up-to-the-moment underlying price to calculate the partial day's return (n+1) from yesterday's URP (n), but we weight this partial day's return by half. Then we consider the very first day and weight that whole day's return by half. In this manner, we still have a full 21-day realized volatility at any moment in time half weight on day 1, half weight on day 22, and full weights for days 2 through 21 (for a total of 21 days of realized volatility).

When the time of day equals the close of Today (n+1), the weight of the return of day n+1 is now 86,400/86,400, or 100%, while the weight of the return of day 1 is 0.00 ((86, 400−86,400)/86, 400). Thus, with its weight of zero, the return of the original day 1 drops out of the calculation. The original day 2 now becomes the new day 1 and all other days get renumbered as well. The real-time close-to-close formula at this very instant in time (the close at 4:00 PM in our example) simplifies to the daily close-to-close formula. The instant after the market closes, we begin anew, with the URPs renumbered, such that there are again only 21 days of the most recent data.

### 5.3.11 Adjustments to Data or Formulas

Since there are weekends, holidays, and potential market disruption events that could occur, it is important to know how the calculation of the indices will be affected by these non-trading, or partially trading, days.

### 5.3.11.1 Weekend Day

In the case of a weekend day, there is no URP or possible calculation of a return, so weekend days will be ignored. In essence, the formulas will continue as if the non-trading weekend days never existed. No index will be calculated or disseminated on weekend days.

### 5.3.11.2 Holidays

In the case of holidays, there is no Underlying Reference Price or possible calculation of a return, so those days will be ignored. In essence, the formulas will continue as if the non-trading holiday never existed. No index will be calculated or disseminated on holidays.

### 5.3.11.3 Market Disruption Event

In the case of a partial day Market Disruption Event (MDE), the calculation agent will determine if there is an Underlying Reference Price. If there is an Underlying Reference Price for the day (in whatever manner that Underlying Reference Price may be determined by the entity primarily responsible for its trading or calculation), the affected index will use the same Underlying Reference Price (even if that Underlying Reference Price represents only a partial day's worth of trading or calculation).

If the MDE prevents the trading or calculation of any Underlying Reference Price for the entire day, no return calculation is possible. However, the index will continue to be calculated and published (if publication is possible). In order to keep the same rolling set of daily returns moving through time, the index cannot simply ignore the originally scheduled trading day that did not occur. Thus, it will use the same set of data normally scheduled for the rolling 21-day version, but will compensate for the missing day's returns by lowering the value of n by the full number of days of MDE.

For example, if today is a scheduled trading day, but the market could not open, and hence the market could not close, the normal 21-day index will be published as a 20-day index for the time period during which the MDE coincides with the normal 21-day returns schedule. In essence, the first day will be dropped as we perform the normal roll process, but the 21^{st} day will not be added because there is no Underlying Reference Price available “today.”

### 5.3.11.4 Multiple MDEs

In the case where the number of MDE days in a period causes the number of days to drop below 20 (described above as the minimum number of data points required for a valid calculation of volatility to occur), the 20-data-point-minimum requirement will be waived and the calculation agent will continue to reduce the number of days in the calculation period to as few as a single day. If, indeed, a MDE causes the underlying to lack pricing for an entire 21-day period, the index will also be unavailable until such time as the Underlying Reference Prices are again available.

### 5.3.11.5 Rolling Methodology

If the underlying is an instrument that expires, such as a futures contract, there is an additional step required in order not to introduce fictitious or “phantom” volatility that is not present. If the underlying is an index, spot price, asset, security, or measurement, this step is not performed and this entire Rolling Methodology section may be ignored.

There comes a point in the life of a futures contract where the front-month contract expires. And, it is logical to assume that the previously deferred month, which now becomes the new front month, then becomes the contract upon which further returns are based. Futures contracts are, as their name implies, based on a prediction—a forecast of a future event. As such, their values are predicated upon many factors, and so it is natural to assume that when one futures contract expires, the next one, chronologically, which may not expire until one month, two months, or perhaps three months, later, may differ in price from the recently expired one. Clearly, when one endeavors to calculate the index based on an underlying, and that underlying is a futures contract, such a “jump” in successive Underlying Reference Prices could be problematic. Why? Consider the following.

Suppose that an underlying March futures contract has just expired at a price of 100. Suppose, further, that, at that very moment of expiration, the deferred underlying June contract is trading at 102. Finally, suppose that, in the next day's trading, the underlying June futures contract remains unchanged and closes once again at 102. In the calculation of a continuing series of closing-settlement returns, one might use the underlying March contract until it stops trading. In this case, the final price is 100. For the next trading day, there is zero inter-day volatility, because the market is unchanged, and yet the new closing reference point would be 102—that of the underlying June contract. In the calculation process, were one to simply “roll” the return calculation from underlying March into underlying June, there would be the appearance of a two-point jump in the reference prices, from 100 to 102, implying some inter-day realized volatility when, in fact, there is none.

To address this potential problem, the rollover method proceeds on the day following the expiration of the underlying futures contract, and the previous day's settlement price of the next contract (now the front month) is used to calculate the next day's return. For example, suppose it is expiration day of the underlying March contract. To ensure continuity of pricing, without the possibility of a “false jump” on the following day, one would immediately resort to referencing the settlement price of the underlying June contract on the expiration day of the underlying March contract, and one would use that price as the first of two that would form the first underlying June return. Doing so would avoid any possibility of a gap or jump in price due solely to the underlying roll process. In other words, while the March contract is “alive,” its daily returns are used solely; on the day after the underlying March expiration, the daily returns of the underlying June contract are used solely. This process is repeated over and over as we move through time and the sequential underlying futures contracts expire.

### 5.3.11.6 Other Adjustments for Phantom Volatility

If the underlying asset were a security, an adjustment would be necessary anytime there is a corporate event that affects the share price (as opposed to normal market forces that cause the value to change). For example, if a company declares a $1.00 dividend, such a dividend is not paid immediately, but scheduled in the future. All market participants know the date by which they must be a shareholder in order to qualify to receive the dividend. The market participants will also know the date on which the dividend is scheduled to be paid. On this so-called “ex-dividend date” this corporate event will affect the share price by dropping the shares by $1.00 but not the value (as the shareholder will now own the stock at $1.00 less in value, but will be owed $1.00 in cash to be paid in his or her account shortly).

Let's assume that no other news or revaluation occurs the whole day. In that event, the stock will drop $1.00 in price and introduce phantom volatility into the price. To eliminate this phantom volatility, the return calculation will reincorporate the dividend into the return calculation for just this one day. For example, suppose a stock closed at $100 per share yesterday. Today, the dividend is paid. The stock price immediately drops to $99. Again, suppose that no other news or revaluation occurs and the stock closes the day at $99 per share. Because the dividend is added back in (on this day only), making both the starting and ending share prices $100, the return calculation for the day is zero.

The following day, let's again assume that the share price does not change. The market, therefore, would close at $99. The return for the day after payment of the dividend would use $99 for “today's” price and $99 for “yesterday's” price to calculate the return (ignoring the dividend completely). In other words, the dividend is added back on only the day it is paid. All other days are unaffected.

A similar adjustment would be needed in the case of a stock split. For example, suppose that the directors declare a two-for-one stock split. On the day that the stock splits, the price of the shares in the marketplace will trade for approximately half, and should trade for exactly half if the market participants feel that no other new information or revaluation has occurred.

Again, the return calculation would be adjusted to account for such a corporate event that affects the share price. In this example, the return calculation will negate the stock split on the day that it occurs by doubling the closing stock price and calculating the return from the prior day's (non-stock split) price.

The stock split is a contrived event that affected the price but not the value of the company. In essence if the price is half but the number of the shares is double, then the value of the company is unchanged. When the value is unchanged, the return calculation for that day should be zero.

As those skilled in the art would readily understand, and instead of providing example after example of phantom volatility, suffice it to say that all events that introduce phantom volatility must be adjusted by reversing the event on the day that it occurs such that the return calculation is affected only by standard market forces and not by a contrived event that does not affect value. Such phantom volatility could occur in any asset. And, in all cases, the return calculation must be adjusted by reversing the effect of such an event on the day of its occurrence.

### 5.3.12 Volatility of Volatility

As we noted, financial instruments can be traded on realized volatility. And, this invention proposes a methodology of defining indices used to settle such contracts at expiration. However, supposing that market participants indeed trade such instruments; they now need to know the riskiness of that instrument. There is a simple way to assess such risk: it is called volatility. Therefore, if one is trading risk itself, then one needs to calculate the volatility of volatility.

As those with ordinary skill in the art would easily understand, running the volatility calculation on the realized volatility index produces another index called the realized volatility of realized volatility index (vol of vol). In other words, volatility can be an asset itself and could be used as an underlying reference asset in a volatility calculation.

### 6 EXAMPLES

The following Examples are provided to illustrate certain aspects of the present invention and to aid those of skill in the art in practicing the invention. These Examples are in no way to be considered to limit the scope of the invention in any manner.

The following is a step-by-step description of the daily RVOL index-calculation methodology provided by the present invention using a spreadsheet such as sold commercially under the trade name EXCEL® (Microsoft, Redmond, Wash.). Other methods for performing the calculations, e.g., using computer programs instead of spreadsheets, will be apparent to those having ordinary skill in the art. Note: The spreadsheet contains data through 1 Mar. 2012.

In column A are trading dates. Weekends and holidays are removed because the calculation ignores those days.

In column B are the closing prices of the underlying corresponding to the date in column A. In this particular case, we use the S&P 500 Index as the underlying, but any underlying with a daily closing price is possible.

In column C is “today's” closing price divided by “yesterday's” closing price. Specifically, cell C2 has the formula “=B2/B1”. This cell is copied down the column such that cell C3 has the formula “=B3/B2”, etc. (Excel changes the reference cells automatically as the initial formula is copied down the spreadsheet.)

In column D is the continuously compounded return of each value in column C. The formula in cell D2 is “=LN(C2)”. Again, this formula is copied down the column and Excel changes the references automatically to the next cell such that cell D3 will now contain the formula “=LN(C3)”, etc.

In column E is the squared return. The formula in column E2 is “=D2̂2”. Note: the “̂” symbol means “to raise the variable to the power of.” So, D2̂2 is equal to the square of D2 (or D2*D2). Again, this cell is copied down the column and Excel changes the relative references.

In column F is the sum of the previous 21 days' returns. The formula in cell F22 is “=SUM(E2:E22)”. In Excel, the “SUM” function adds all items within the parentheses. And, in this case, “E2:E22” is the accepted notation to include everything in the cell starting with E2 and continuing in order through E22. Therefore, the “=SUM(E2:E22)” is equivalent to “=SUM(E2, E3, E4, E5, . . . , E22)”, and in mathematical notation, this is equivalent to E2+E3+E4+E5+ . . . +E22. The formula gets copied down the page in a similar manner as described above. Excel automatically changes the formula reference each time such that cell F23 would have the formula “=SUM(E3:E23)”, etc.

In column G is the average of the 21 days' returns. To get the average, divide each value in column F by 21. The formula in G22 is “=F22/21”. Again, this value is copied down the column.

In column H is the annualization factor. To annualize the value, just multiply each value in column G by 252 (the approximate number of trading days in a year). The formula in cell H22 is “=G22*252”. Note: The symbol “*” means to multiply. Again, copy the formula down the column.

In column I is the square root of each value in column H. The formula in cell 122 is “=SQRT(H22)”. “SQRT” is the built-in function in Excel that takes the square root of the number within the parentheses. Again, this cell is copied down the column.

In column J is the removal of the percentage sign by multiplying the result in column I by 100. The formula in cell J22 is “=I22*100”.

In column K is the “Daily RealVol U.S. 500 Index.” The formula in K22 is “=J22”.

As you will notice, it takes 22 days of closing prices to calculate 21 days of returns. And, the first 21 returns are needed in order to calculate the very first RVOL daily index value. Therefore, whatever Underlying Reference Prices are used, an RVOL daily index cannot produce its very first value until 21 days have passed. However, please note that this is a one-time issue. The S&P 500 index has been available in its current form since 1957 (the author believes that the index was actually started in January 1957). Therefore, the RVOL index based on the underlying of S&P 500 index can be calculated back to February 1957 (approximately one month after the launch of the underlying) and would be continuous since then.

For clarification, the example shows that the daily RVOL index started in February 2012. This was done simply for explanatory purposes. The daily RVOL index values easily could have been calculated for January 2012 with data from December 2011. And, data for December 2011 could have been calculated with data in November 2011, and so on, back in time all the way to February 1957.

### 6.1 Real-Time VOL Index Spreadsheet Example

The following is a step-by-step description of the real-time index calculation methodology provided by the present invention, using spreadsheet software such as sold under the trade name EXCEL® (Microsoft, Redmond, Wash.). Other methods for performing the calculations, e.g., using computer programs instead of spreadsheets, will be apparent to those having ordinary skill in the art.

In this example, we assume that “today” is 2 Mar. 2012, that we have daily index data every day to 1 Mar. 2012 (as described above), that the current time is 9:35 am on 2 March, and that the current underlying price is 1371.26.

Note: The rows of the spreadsheet do not correspond to the counter “n” in the formula.

In the below examples, the first day (n=1) can be found in row 22. For n=2, this corresponds to row 23. Similarly, n=3 is in row 24, etc., until we get to n=22 in row 43. For clarification, as we move through time, 2 Mar. 2012 closes, and we move to trading on 3 Mar. 2012, the “n” values get renumbered such that the first day (n=1) can now be found in row 23, with n=22 in row 44, etc.

In cell L43, we place the current underlying price; in this case it is 1371.26.

In cell M43, we place the date and time of the close from the previous day. In this case, we assume 1 Mar. 2012 at 4:00 pm.

In cell N43, we place the current date and time; in this case it is assumed to be 9:35 am on 2 Mar. 2012.

In column O, we calculate the days' weights. First, today's weight is calculated according to the specific portion of a day. In this case, 9:35 am is 73.26% of the way through the trading day (based on the closing time yesterday of 4:00 pm). Internally, Excel calculates this value with the formula “=N43−M43”. After we determine the weight of day 22 (in this case, 73.26%), we subtract that value from 100%, and the result becomes the weight accorded to day 1 (found in cell O22). The formula in cell O22 is “=100%−O43”. The value in this case is 26.74%. Each of the rest of the days 2-21 has a 100% weight. Thus, we have 22 data points but with the cumulative weight of 21 data points (weight of day 1 and weight of day 22 total 100% of a single day's weight together, not separately).

In column P, we calculate the close “today” divided by the close “yesterday.” For n=1 through n=21, this was already calculated in column C (see exhibit #2). The only value not yet calculated is “today's value” divided by “yesterday's” close. Note: “today's value” is not yet the close. We use the current underlying price to provide a real-time indication of the daily index. In cell P43 is the formula “=L43/B42”.

In column Q is the continuously compounded return. Since this was already calculated for days 1-21, in column D, the only calculation remaining is for “today's” value. Cell Q43 contains the formula “=LN(P43)”.

In column R are the squared returns. Since this was already calculated for days 1-21 in column E, the only calculation remaining is for “today's” value. Cell R43 contains the formula “=Q43′2”.

In column S are the weighted squared returns. Take the weight of each cell in column O and multiply it by its corresponding squared returns. Cell S22 contains the formula “=E22*O22”. This formula is copied down the column except for the very last row (“today”). This formula is slightly different from the one above because we are calculating the squared return using the current underlying price instead of the close. Therefore, in cell S43, we use the formula “=R43*O43”.

In column T is the sum of the weighted squared returns. The formula in cell T43 is “=sum(S22:S43)”.

In column U is the average of the 21 days' returns. To get the average, divide the value in cell T43 by 21. The formula in cell U43 is “=T43/21”.

In column V is the annualization factor. To annualize the value, multiply the value in cell U43 by 252. The formula in cell V43 is “=U43*252”.

In column W is the square root. The formula in cell W43 is “=SQRT(V43)”.

In column X is the removal of the percentage sign by multiplying the result by 100. The formula in cell X43 is “=W43*100”.

In column Y is the “real-time index value.” The formula in Y43 is “=X43”.

### 7 CONCLUSION

Thus, the present invention will be seen by those having ordinary skill in the art to provide an important advance in finance, especially in evaluating price risks. Obviously, based on only the disclosure herein, several indices could be created by varying the predetermined time frame. Other indices could be created by varying the formula for calculating realized volatility (there are several). Yet, other indices could be created by incorporating realized volatility with other statistical measures. Therefore, this novel invention shows one of ordinary skill to create indices based on realized volatility. By varying the formula or the time frame, and incorporating realized volatility as the basis for other statistical measurements, one can create a panoply of indices that measure the actual price risk of some underlying asset.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

What is claimed:

1. An electronic, computer-controlled system for electronically creating, calculating, recording, and disseminating standardized indices based on the actual price risk of an underlying, comprising: computer-accessible, computer-controlled electronic memory holding electronically encoded representations of indicies, said representations of said indicies being determined at least in part by electronic computer-controlled calculations of the actual price movements of said underlying and said representations being further determined by electronic computer-controlled calculations based on electronically encoded representations of non-trading days, rolling between expiring underlyings, market disruption events, and phantom volatility of said underlying.

2. The electronic, computer-controlled system of claim 1, wherein said electronically encoded representations of said indices are further determined by electronic computer-controlled calculations based on electronically encoded representations of predetermined time periods of said underlying.

3. The electronic, computer-controlled system of claim 1, wherein said time periods are one-day, approximately one-week, approximately one-month, approximately three-month, or approximately twelve-month time periods of said underlying.

4. The electronic, computer-controlled system of claim 1, wherein said electronically encoded representation is further determined by electronic computer-controlled calculations based on electronically encoded representations of inter-day realized volatility of said underlying.

5. The electronic, computer-controlled system of claim 1, wherein said electronically encoded representation is further determined by electronic computer-controlled calculations based on electronically encoded representations of intra-day realized volatility of said underlying.

6. The electronic, computer-controlled system of claim 1, wherein said electronically encoded representation is further determined by electronic computer-controlled calculations of electronically encoded models of forecast realized volatility and realized volatility of volatility of said underlying.

7. The electronic, computer-controlled system of claim 1, wherein said electronically encoded representation is further determined by electronic computer-controlled calculations based on electronically encoded representations of the realized volatility of realized volatility of said underlying.

8. The electronic, computer-controlled system of claim 1, wherein said electronically encoded representation is further determined by electronic computer-controlled calculations based on electronically encoded representations of the realized correlation between said underlying and the realized volatility of said underlying.

9. The electronic, computer-controlled system of claim 1, wherein said electronically encoded representation is further determined by electronic computer-controlled calculations based on electronically encoded representations of the realized correlation of a plurality of underlyings.

10. The electronic, computer-controlled system of claim 1, wherein said underlying is an index, and said electronically encoded representation is further determined by electronic computer-controlled calculations based on electronically encoded representations of the realized volatility of said underlying and the realized volatility of the components of said underlying.

11. The electronic, computer-controlled system of claim 1, wherein said electronically encoded representation is further determined by electronic computer-controlled calculations based on electronically encoded representations of real-time realized volatility of said underlying.

12. The electronic, computer-controlled system of claim 1, wherein said electronically encoded representation is further determined by electronic computer-controlled calculations based on electronically encoded representations of inter-day, intra-day, daily, or real-time realized variance of said underlying.

13. A method for electronically creating, calculating, recording, and disseminating standardized indices based on the actual price risk of an underlying, comprising: calculating under computer control electronically encoded representations of actual price movements for said underlying using electronic, computer-controlled calculations of electronically encoded representations of non-trading days, rolling between expiring underlyings, market disruption events, and phantom volatility of said underlying; and electronically calculating under computer control electronic representations of said indices using electronic, computer-controlled calculations of said electronically encoded representations of said actual price movements.

14. The method of claim 13, wherein said electronically encoded representations of said indices are further determined by electronic computer-controlled calculations based on electronically encoded representations of predetermined time periods of said underlying.

15. The method of claim 13, wherein said time periods are one-day, approximately one-week, approximately one-month, approximately three-month, or approximately twelve-month time periods of said underlying.

16. The method of claim 13, wherein said electronically encoded representation is further determined by electronic computer-controlled calculations based on electronically encoded representations of inter-day realized volatility of said underlying.

17. The method of claim 13, wherein said electronically encoded representation is further determined by electronic computer-controlled calculations based on electronically encoded representations of intra-day realized volatility of said underlying.

18. The method of claim 13, wherein said electronically encoded representation is further determined by electronic computer-controlled calculations of electronically encoded models of forecast realized volatility and realized volatility of volatility of said underlying.

19. The method of claim 13, wherein said electronically encoded representation is further determined by electronic computer-controlled calculations based on electronically encoded representations of the realized volatility of realized volatility of said underlying.

20. The method of claim 13, wherein said electronically encoded representation is further determined by electronic computer-controlled calculations based on electronically encoded representations of the realized correlation between said underlying and the realized volatility of said underlying.

21. The method of claim 13, wherein said electronically encoded representation is further determined by electronic computer-controlled calculations based on electronically encoded representations of the realized correlation of a plurality of underlyings.

22. The method of claim 13, wherein said underlying is an index, and said electronically encoded representation is further determined by electronic computer-controlled calculations based on electronically encoded representations of the realized volatility of said underlying and the realized volatility of the components of said underlying.

23. The method of claim 13, wherein said electronically encoded representation is further determined by electronic computer-controlled calculations based on electronically encoded representations of real-time realized volatility of said underlying.

24. The method of claim 13, wherein said electronically encoded representation is further determined by electronic computer-controlled calculations based on electronically encoded representations of inter-day, intra-day, daily, or real-time realized variance of said underlying.

25. A non-transitory computer-readable medium containing a computer program product for operating a computer data processing device having an operating system, said computer program product being configured to enable said computer data processing device to electronically create, record, trade, and settle standardized indices based on the actual price risk of an underlying, said computer program product being configured to enable said computer data processing device to perform actions comprising: calculating under computer control electronically encoded representations of actual price movements for said underlying using electronic, computer-controlled calculations of electronically encoded representations of non-trading days, rolling between expiring underlyings, market disruption events, and phantom volatility of said underlying; and electronically calculating under computer control electronic representations of said indices using electronic, computer-controlled calculations of said electronically encoded representations of said actual price movements.

26. The non-transitory computer-readable medium of claim 25, wherein said electronically encoded representations of said indices are further determined by electronic computer-controlled calculations based on electronically encoded representations of predetermined time periods of said underlying.

27. The non-transitory computer-readable medium of claim 25, wherein said time periods are one-day, approximately one-week, approximately one-month, approximately three-month, or approximately twelve-month time periods of said underlying.

28. The non-transitory computer-readable medium of claim 25, wherein said electronically encoded representation is further determined by electronic computer-controlled calculations based on electronically encoded representations of inter-day realized volatility of said underlying.

29. The non-transitory computer-readable medium of claim 25, wherein said electronically encoded representation is further determined by electronic computer-controlled calculations based on electronically encoded representations of intra-day realized volatility of said underlying.

30. The non-transitory computer-readable medium of claim 25, wherein said electronically encoded representation is further determined by electronic computer-controlled calculations of electronically encoded models of forecast realized volatility and realized volatility of volatility of said underlying.

31. The non-transitory computer-readable medium of claim 25, wherein said electronically encoded representation is further determined by electronic computer-controlled calculations based on electronically encoded representations of the realized volatility of realized volatility of said underlying.

32. The non-transitory computer-readable medium of claim 25, wherein said electronically encoded representation is further determined by electronic computer-controlled calculations based on electronically encoded representations of the realized correlation between said underlying and the realized volatility of said underlying.

33. The non-transitory computer-readable medium of claim 25, wherein said electronically encoded representation is further determined by electronic computer-controlled calculations based on electronically encoded representations of the realized correlation of a plurality of underlyings.

34. The non-transitory computer-readable medium of claim 25, wherein said underlying is an index, and said electronically encoded representation is further determined by electronic computer-controlled calculations based on electronically encoded representations of the realized volatility of said underlying and the realized volatility of the components of said underlying.

35. The non-transitory computer-readable medium of claim 25, wherein said electronically encoded representation is further determined by electronic computer-controlled calculations based on electronically encoded representations of real-time realized volatility of said underlying.

36. The non-transitory computer-readable medium of claim 25, wherein said electronically encoded representation is further determined by electronic computer-controlled calculations based on electronically encoded representations of inter-day, intra-day, daily, or real-time realized variance of said underlying.
